(19) United States
(12) Patent Application Publication
(10) Pub. No.: US 2002/0186329 A1
(43) Pub. Date: Dec. 12, 2002

(54) Electronic content modules and display dock

(75) Inventors: Hing S. Tong, Saratoga, CA (US); Darwin Chang, Cupertino, CA (US); Philip K. Siu, Los Altos, CA (US)

Correspondence Address: LAW OFFICE OFTHOMAS E. SCHATZEL, A Professional Corporation, 16400 Lark Avenue, Suite 240, Los Gatos, CA, 95032-2547, US

(73) Assignee: EHOMETV [HK] LTD.,

(21) Appl. No.: 09/877,352

(22) Filed: Jun. 7, 2001

(51) Int. Cl. H04N 5/64

(52) U.S. Cl. 348/839; 348/552

(57) ABSTRACT

A content-module and display-dock system comprises a cabinet with a video picture tube and loudspeaker. A module dock is provided in back to receive a variety of personality modules. Inside, a processor converts digital or analog video signals as needed. A microcomputer supports the docking module interfacing. The personality modules include Internet access, browsing, e-mail, television, video game, and other services. The modular system is customized by assembling particular modules and display docks together.

### FIELD OF THE INVENTION

The present invention relates to electronic user appliances, and more particularly to a docking station with a video screen and audio speaker able to receive a variety of electronic content modules including Internet browser, e-mail client, television receiver, video game unit, video tape player, etc.

### DESCRIPTION OF THE PRIOR ART

Video display, television, and Internet browser technologies are advancing at a very rapid pace. It is difficult for manufacturers to field new products with the new technologies before the next new advance comes out. Very often the tooling expense is very high and the production runs are foreshortened.

It is now apparent to many that television, telephone, and Internet technologies are converging. TV news sound bytes are being delivered over the Internet to browsers, and “free” phone calls on the Internet have become very popular. Many advertisers in various media cite their web addresses so the consumer can find out more, and many websites list their phone numbers so the customer can call them. Internet shoppers can pay for purchases with credit cards, ship their packages via UPS, and track both their order status and shipment on the Web. Banks offer account access to credit card and banking accounts both by telephone and by the Internet. Hotels allow their guests to checkout using the room TV and its remote control.

The result is things are changing too fast on all fronts to get a respectable return-on-investment. What is needed is a modular system in which the technology-affected areas can be isolated, removed, and substituted. This without having to retool and redesign the unaffected parts.

### SUMMARY OF THE INVENTION

It is therefore an object of the present invention to provide a modular system in which a variety of electronic content modules can be plugged quickly and easily into a display dock.

It is another object of the present invention to provide a business model for maximizing manufacturing profits.

It is a further object of the present invention to provide a method for using new technologies as they appear.

It is a still further object of the present invention to provide a system that fuses Internet, television, telephone, and entertainment products together in one very affordable appliance.

Briefly, a content-module and display-dock system embodiment of the present invention comprises a cabinet with a video picture tube and loudspeaker. A module dock is provided in back to receive a variety of personality modules. Inside, an analog processor converts digital video signals from a docking interface to the analog signals needed by the picture tube. A microcomputer supports the docking module interfacing. The personality modules include Internet access, browsing, e-mail, television, video game, and other services. The modular system is customized by assembling particular modules and display docks together.

An advantage of the present invention is that a system and method are provided in which a target consumer appliance can be assembled from major finished assemblies just-in-time.

Another advantage of the present invention is that a system and method are provided that improve consumer access to new technologies and services.

A further advantage of the present invention is that a system and method are provided that integrates television, telephone, Internet, e-mail, etc., technologies.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a content-module and display-dock system embodiment of the present invention;

FIG. 2 is a functional block diagram of a display docking interface used in the system of FIG. 1;

FIG. 3 is a schematic diagram of a consumer appliance embodiment of the present invention which shows the electrical connection interrelationships between a CRT or LCD, analog switches, personality module, module dock, analog processor, and CPU; and

FIG. 4 is a top view of a consumer appliance showing the internal physical placement of a CRT or LCD, display dock printed circuit board, personality module, module dock, analog processor, and CPU.

### DETAILED DESCRIPTION OF THE PREFERRED EMBODIMENT

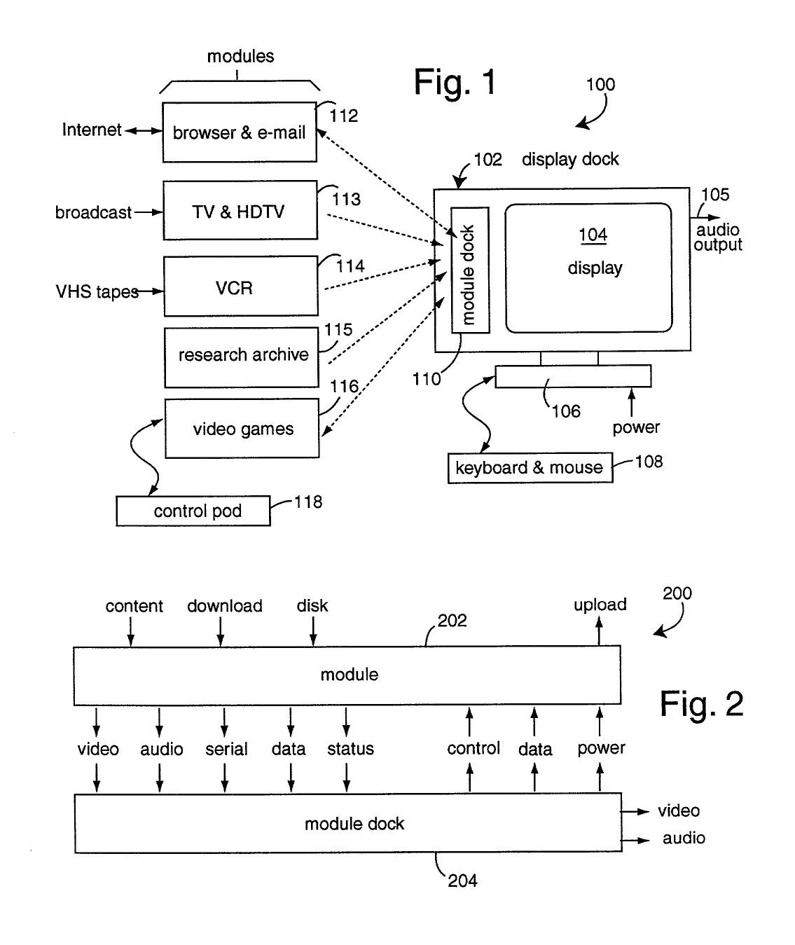

FIG. 1 illustrates a content-module and display-dock system embodiment of the present invention, and is referred to herein by the general reference numeral 100. The system 100 comprises a display dock 102 for table-top use. Power can come from dock 102 or from an external source if lots of power is needed. The display dock 102 includes a video display screen 104, an audio output 105, a base 106, and a keyboard and mouse combination 108. A module dock 110 provides a mechanical socket and electrical interface for a variety of interchangeable modules 112-116.

For example, a module 112 provides a complete TCP/IP connection for the Internet and the browser and e-mail clients needed to surf the Web and send/receive e-mail. Alternatively, the TCP/IP connection can be substituted by DSL, ISDN, satellite, or dial-up modem. Module 112 includes the computer hardware and software to run these applications, and the display dock 102 simply displays the video and outputs the audio sound. The keyboard and mouse combination 108 can be used to support user navigation, or a wireless keyboard could be interfaced directly to the module 112. Wireless “Bluetooth” or IEEE-802.11 a LAN connections can also be used instead of an ordinary TCP/IP cable connection.

Module 113 receives off-the-air television broadcasts, tunes the stations, demodulates the audio and video, and forwards the amplified signals to the display dock. As HDTV develops and becomes more affordable, upgraded modules 113 can be substituted and a display dock with the wider aspect ratio screens can be used.

Module 114 is essentially a VHS-type VCR, DVD, VOD or video disk player. Tapes and disks can be rented or purchased for replays.

Module 115 can be a video recorder and is primarily constructed from very large-storage disk drives. The ability to inexpensively record and store massive amounts of data is expected to be a growth industry in the future with many as-yet-unidentified applications for consumers and businesses. With current technologies, 10G-byte hard disk drives and their drive controllers could be built into a standard size docking module. Future storage capacities are expected to increase exponentially while the drive prices themselves drop.

Module 116 is a video game unit, and includes both the latest game software and the specialized processors needed to run them. A control pod 118 can be connected that has specialized gaming controls, e.g., two-player joysticks.

FIG. 2 represent a docking interface 200 useful in the system 100 (FIG. 1). A module 202 is interfaced to a module dock 204. Each module 202 receives operating power, control signals, and data from the module dock 204. In return, the modules 202 variously generate video, audio, serial, data, and status signals. The module dock includes NTSC-composite demodulators, video amplifiers, color amplifiers, raster deflection circuitry, audio amplification, and power supplies.

Most importantly, the docking interface 200 is electrically and mechanically standardized so that a variety of manufacturers can successfully produce interchangeable products. It would be advantageous if “hot-swapping” was supported, in which powered-up modules could be freely unplugged and plugged-in without damage caused by voltage transients. One way to implement this is with ground contacts that make first and break last, and buffers and filters for the signal lines.

For example, the Digital Display Working Group (DDWG) industry coalition has circulated a digital visual interface (DVI) standard that would be preferred in particular. The DVI standard defines connections between digital hosts and displays. A current copy of the DDWG-DVI standard is lodged with this patent application in an Information Disclosure Statement. Such Standard would be useful in implementations of embodiments of the present invention.

Similarly, the Video Electronics Standards Association (VESA) (Milpitas, Calif.) has published their interface standard. The extended display identification data (EDID) standard defines a standardized data format that encodes information about a display's capabilities. Such information allows a display driver to adapt for best possible performance, on a case-by-case basis.

A memory device, such as a serial-interface read-only memory (ROM) is included in the module dock 204 and can be interrogated for display configuration information from the module 202. In some applications, it may be preferably to have such interrogation be possible even if the module dock 204 or display dock 102 is powered down.

Power management support is also preferably included in the module dock 204 such that go-to-sleep and wake-up signals can be issued from the module 202.

Individual signal communication standards are also preferably included, e.g., RS-232, universal serial bus (USB), Philips inter-IC control I2C, infrared (IR) serial, power management signaling, and display data channel (DDC) monitor communications support. Well-known video standards like NTSC, PAL, and SECAM are preferably accommodated.

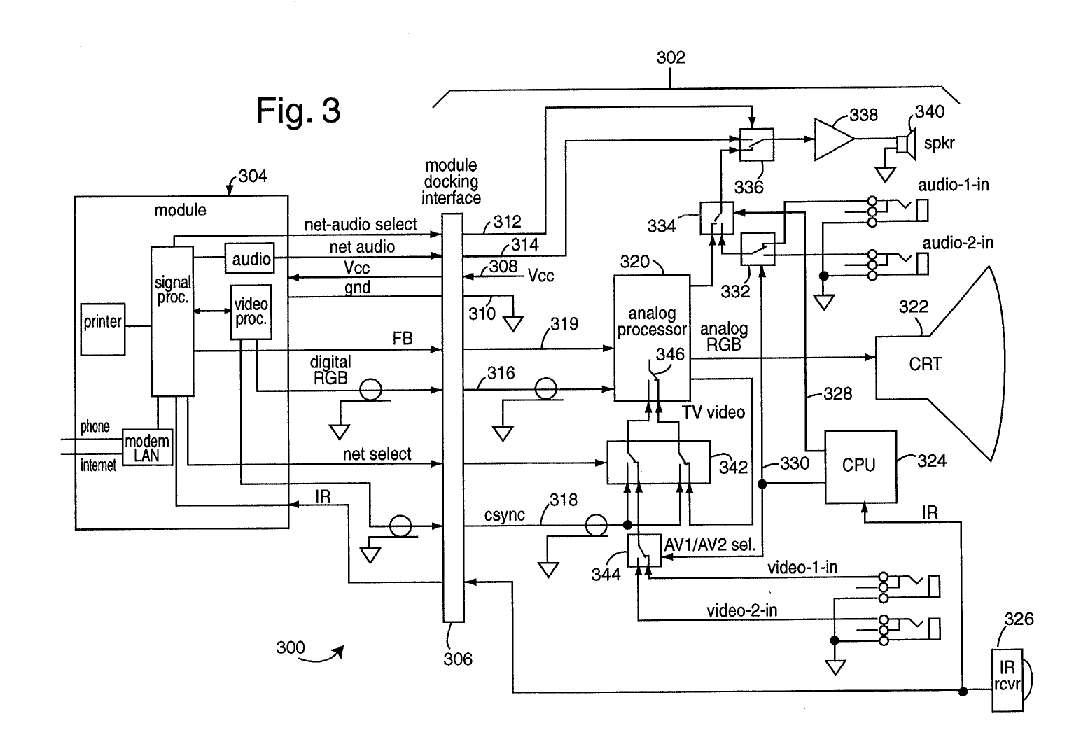

FIG. 3 represents a consumer appliance embodiment of the present invention, and is referred to herein by the general reference numeral 300. The appliance 300 resembles a table-top television receiver, and comprises a docking display 302 that can accept a variety of plug-in personality modules, e.g., a module 304 that includes a signal processor, video processor, printer, communications interface, and audio functions. These connect with the docking display 302 at an interface 306.

In the example illustrated in FIG. 3, the module 304 receives its operating power (Vcc) and ground rails on a pair of connections 308 and 310. The signal processor can be implemented with a Cirrus Logic (Fremont, Calif.) CL-PS7500FE System-on-a-Chip for Internet Appliance and the video processor with a Chrontel (San Jose, Calif.) CH7003 Digital PC to TV Encoder. A connection 312 is provided for audio source selection, and a connection 314 carries an analog audio channel. A digital red-green-blue (RGB) connection has at least three wires and is accompanied by a synchronizing (CSYNC) signal connection 318. CSYNC can be replaced by NSYNC or VSYNC. A connection 319 allows the module 304 to control video input sources to an analog processor 320.

In one implementation of the present invention, the analog processor 320 decodes digital pixel data streams, e.g., from VGA controllers, and converts the information into analog drives for a cathode ray tube (CRT) 322.

A microcomputer (CPU) 324 controls most of the functioning and operation of the appliance 300, and it responds to a handheld remote control signal picked up by an infrared (IR) receiver 326. A first output signal 328 is able to select internal or external audio input sources, and a second output signal 330 can select between external video input sources.

In one implementation of the present invention, the CPU 324 includes an ARM7 RISC-processor CPU core, floating point mathematics, video and sound processing, memory, analog input ports, and serial I/O.

The appliance 300 further includes a group of analog switches 332, 334, and 336 that allow the analog processor 320, CPU 324, and module 304 to select which audio source will be applied to an audio power amplifier 338 and loudspeaker 340. Another group of analog switches 342, 344, and 346 allow the analog processor 320, CPU 324, and module 304 to select which video source and synch signal will be used in the analog processor 320 for output to CRT 322. For digital LCD, the analog processor will not be present in the design.

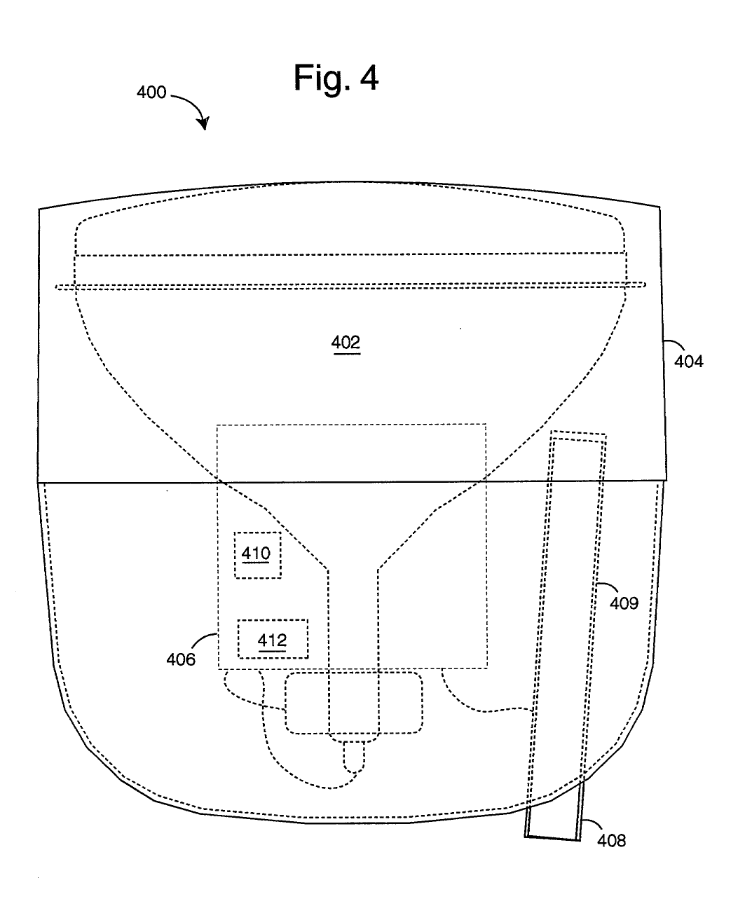

FIG. 4 shows a top plan view of a practical way in which the components of a consumer appliance 400 can be physically arranged in a table-top cabinet. A picture tube (CRT) 402, shown in phantom, is mounted in the front of a plastic cabinet 404. A typical screen size would be nineteen-inches diagonally measured. A display dock printed circuit board 406 is mounted in the bottom of the cabinet 404 below the CRT 402. A personality module 408 slips into a dock 409 from behind the cabinet. An analog processor 410 and a microcomputer 412 like those of FIG. 3 are disposed on the PCB 406 and connect to the dock 409 and CRT 402. The whole is powered by typical household current, e.g., 110 VAC, 60-cycle.

A method embodiment of the present invention for increasing component production volumes and improving consumer electronic product profitability comprises (1) separating the functionality of a consumer appliance into a display dock and a content module, wherein each are independent, (2) including a platform for a video display screen and an audio output subsystem in the display dock, (3) hosting a variety of content application functions in a corresponding plurality of interchangeable content modules, and (4) combining the display dock and the content module into one consumer product to order just-in-time before shipment. Such method may further comprise, (5) building an included interface between the display dock and the content that conforms to a public technical standard.

A method for consumer-electronic-product business comprises (1) separating the functionality of a consumer appliance into a display dock and a content module, wherein each are independent, (2) building an included interface between the display dock and the content that conforms to a public technical standard, (3) including a platform for a video display screen and an audio output subsystem in the display dock, (4) hosting a variety of content application functions in a corresponding plurality of interchangeable content modules, (5) combining the display dock and one of the plurality of interchangeable content modules into one consumer product to order just-in-time before shipment, and (5) licensing a third-party to make, use, or sell at least one of the display dock and the content module. For example, such licensing can be pursuant to a trade secret, a patent, and/or a copyright. The licensing may also include design know-how, or so-called “intellectual property” that comprises hardware description files and synthesizable design libraries.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A content-module display-dock system, comprising,
a cabinet with an internal power supply for operating electronic devices disposed inside that include a removable plug-in personality module;
a video display screen disposed about a front wall of the cabinet;
an audio output subsystem disposed in the cabinet;
a network of analog switches connected to route a number of audio and video sources for output by the audio output subsystem and the video display screen;
a module docking interface for electrically and mechanically interfacing to said removable plug-in personality module, and including at least one source of audio and video signals connected to the network of analog switches;
an analog processor for converting a digital video signal present at the module docking interface into an analog video signal for forwarding and selection to the network of analog switches; and
a microcomputer connected to control the network of analog switches and in communication with the module docking interface.

2. The system of claim 1, wherein:
the module docking interface includes at least one signal connection that conforms to a public technical standard.

3. The system of claim 1, wherein:
the module docking interface in its entirety conforms to a public technical standard such that a variety of said personality modules from a plurality of manufacturers can be hosted and interchanged.

4. The system of claim 1, further comprising:
a television receiver disposed in said personality module for reproducing television programming on the video display screen and audio output subsystem.

5. The system of claim 1, further comprising:
an Internet client disposed in said personality module and including a browser for visiting websites and showing them on the video display screen and audio output subsystem.

6. The system of claim 1, further comprising:
an e-mail client disposed in said personality module and including an application program for showing received e-mail on the video display screen and audio output subsystem.

7. The system of claim 1, further comprising:
a mass storage memory subsystem disposed in said personality module for providing for a selective showing of achieved data on the video display screen and audio output subsystem.

8. The system of claim 1, further comprising:
a video game subsystem disposed in said personality module for providing for interactive game play with a user on the video display screen and audio output subsystem.

9. A method for increasing component production volumes and improving consumer electronic product profitability, the method comprising:
separating the functionality of a consumer appliance into a display dock and a content module, wherein each are independent;
including a platform for a video display screen and an audio output subsystem in said display dock;
hosting a variety of content application functions in a corresponding plurality of interchangeable content modules; and
combining said display dock and said content module into one consumer product to order just-in-time before shipment.

10. The method of claim 9, further comprising:
building an included interface between said display dock and said content that conforms to a public technical standard.

11. A method for consumer-electronic-product business, the method comprising:
separating the functionality of a consumer appliance into a display dock and a content module, wherein each are independent;
building an included interface between said display dock and said content that conforms to a public technical standard;
including a platform for a video display screen and an audio output subsystem in said display dock;
hosting a variety of content application functions in a corresponding plurality of interchangeable content modules;
combining said display dock and one of said plurality of interchangeable content modules into one consumer product to order just-in-time before shipment; and
licensing a third-party to make, use, or sell at least one of said display dock and said content module.
